(19) United States
(12) Patent Application Publication
(10) Pub. No.: US 2022/0226719 A1
(43) Pub. Date: Jul. 21, 2022

(54) SYSTEM AND METHOD FOR BOWLING GAME THROUGH NETWORK INTERCONNECT

(71) Applicants: Kyoung Hoon KIM, Seoul (KR); MDPERT Co., Ltd., Seoul (KR)

(72) Inventor: Kyoung Hoon KIM, Seoul (KR)

(73) Assignees: MDPERT Co., Ltd., Seoul (KR); Kyoung Hoon Kim, Seoul (KR)

(21) Appl. No.: 17/565,505

(22) Filed: Dec. 30, 2021

(30) Foreign Application Priority Data
Jan. 15, 2021 (KR) 10-2021-0005693

(51) Int. Cl. A63D 5/04; A63B 71/06

(52) U.S. Cl. CPC A63D 5/04; A63B 71/0669; A63B 2225/52; A63B 2220/806; A63D 2005/048

(57) ABSTRACT

A system for a bowling game through a network interconnect includes: an information collection unit collecting bowling game participation information and bowling alley information input from a portable device and a bowling alley server interconnected and accessing a network; a bowling game creation unit creating a team member by applying a penalty for each bowling average of each player based on the collected bowling game participation information; a score management unit calculating scores of each player and each team member, and determining rankings by using a bowling game image of each player transferred from each bowling alley based on the created team member; and a sharing support unit interlocking respective corresponding bowling alley servers with each other, authenticating a player performing the bowling game based on a screen image or motion information photographed, and transferring bowling game related information to the portable device.

### TECHNICAL FIELD

The present invention relates to a system and a method for a bowling game, and particularly, to a system and a method for a bowling game through a network interconnect, which allow each player at a remote distance to participate in a bowling game in real time through a network interconnect.

### BACKGROUND ART

In a bowling alley, lanes having a width of approximately 1 m and a length of approximately 23 m should be installed according to an international standard, a transport system for recovery of a ball is provided below the lane, and an apparatus for recovering and arranging pins should be equipped, and as a result, a large scale space and large scale facilities are required. In addition, there is a problem in that large energy cost and management cost for cleaning, maintenance, etc., are required for maintaining the facilities.

Accordingly, the bowling game is a popular sport, but large initial facility cost and management cost are required, while a profitability is not good, and as a result, the bowling alleys almost disappear in a downtown area.

However, the bowling game may be enjoyed by multiple persons, and is a sound sport which is also helpful to enhance a physical strength, so the bowling alley will be a facility further required even in the downtown area where there are many workers in fatigue. However, as described above, since the bowling alley is a high cost business, when the bowling alley is operated in the downtown area, a deficit operation is inevitable, so there is a problem in that the bowling alley cannot be found in the downtown area.

Meanwhile, in recent years, the number of dissemination and the number of users for a cloud system has bee increased, and as the cloud system is widely used, a large amount of data are accumulated, and while the need of analysis for the data is on the rise, a scale of a market for big data analysis also increases. Accordingly, technologies adopting the cloud system and the big data analysis are further required in various fields through a network interconnect.

### PRIOR ART DOCUMENT

### Patent Document

(Patent Document 1) Korean Patent Unexamined Publication No. 10-2000-0037421 (Publication date: Jul. 5, 2000)
(Patent Document 2) Korean Patent Registration No. 10-1905856 (Registration date: Oct. 1, 2018)

### DISCLOSURE

### Technical Problem

Accordingly, the present invention is contrived to solve the problem, and an object of the present invention is to provide a system and a method for a bowling game, and particularly, to a system and a method for a bowling game through a network interconnect, which allow each player at a remote distance to participate in a bowling game in real time through a network interconnect.

An object of the present invention is to provide a system and a method for a bowling game through a network interconnect, which extract numerical information from an image of the bowling game which is in progress in offline and calculate a record for each player to provide the record through a player's individual portable device.

An object of the present invention is to provide a system and a method for a bowling game through a network interconnect, which allow a bowling alley operation in a downtown area not to be required by removing local and positional restrictions through network interconnect to allow a bowling alley manager to reduce economic cost.

An object of the present invention is to provide a system and a method for a bowling game through a network interconnect, which are capable of managing information on a member, and construct a database capable of providing a result calculated for each player according to a bowling game result to the player's individual portable device.

An object of the present invention is to provide a system and a method for a bowling game through a network interconnect, which can prevent dishonesty of the bowling game performed contact-free through authentication of a player who plays the bowling game through a motion sensor (camera), etc.

An object of the present invention is to provide a system and a method for a bowling game through a network interconnect, which increase accuracy of a player and bowling alley information by utilizing a cloud service with a big data analysis module, and are capable of verifying a more accurate score of a bowling average of each player to further increase fairness for creation of a team member.

The objects of the present invention are not limited to the above-mentioned objects, and other objects and advantages of the present invention that are not mentioned can be understood by the following description, and will be more clearly understood by embodiments of the present invention. Further, it will be readily appreciated that the objects and advantages of the present disclosure can be realized by means and combinations shown in the claims.

### Technical Solution

In order to achieve the object, a feature of a system for a bowling game through a network interconnect according to the present invention may include: an information collection unit collecting bowling game participation information and bowling alley information input from a portable device and a bowling alley server interconnected and accessing a network; a bowling game creation unit creating a team member by applying a penalty for each bowling average of each player based on the collected bowling game participation information; a score management unit calculating scores of each player and each team member, and determining rankings by using a bowling game image of each player transferred from each bowling alley based on the created team member; and a sharing support unit interlocking respective corresponding bowling alley servers with each other in order to conduct the created bowling game, authenticating a player performing the bowling game based on a screen image or motion information photographed by a camera provided in each bowling alley, and transferring bowling game related information including an image of the conducted bowling game, and the scores of each player and each team member to the portable device.

Preferably, the information collection unit may include a participation information collection unit collecting bowling game participation information including unique player information and bowling game room information input from the portable device and a bowling alley information collection unit collecting bowling alley information including unique information of the bowling alley and unique information of a bowling rail input from the portable device.

Preferably, the bowling game creation unit may include a penalty calculation unit detecting bowling averages of all players who participate in the bowling game room in a storage unit and calculating a penalty value between each player based on a difference between the detected bowling average, a team member creation unit creating a team member having a smallest penalty value when each player is tied to the team member by using the penalty value calculated by the penalty calculation unit, a game conduct creation unit conducting the bowling game by providing team member information to the portable devices of all players as the team member created by the team member creation unit, and an expected score calculation unit calculating expected information of the game by using the bowling average of each player included in the team member created by the team member creation unit.

Preferably, the score management unit may include an image recognition unit recognizing the bowling game image including each player and bowling pin images photographed by a camera provided in the bowling alley on the bowling rail of each bowling alley, a score calculation unit calculating the bowling scores of each player and team member by using the recognized bowling game image, a ranking calculation unit calculating the rankings of each player and team member for each bowling game based on the calculated bowling scores, and a record management unit storing the bowling scores and the rankings in the storage unit for each player and for each team member based on the calculated bowling scores and rankings.

Preferably, the sharing support unit may include a bowling alley interlocking unit interlocking the respective corresponding bowling alley servers with each other based on the unique information of the bowling alley and the unique information of the bowling rail input fro the portable device in order to conduct the bowling game created by the bowling game creation unit, a sensor recognition unit recognizing the screen image and motion information photographed by the camera provided in each bowling alley, a player matching unit authenticating whether a corresponding player is a proper player through whether the players are matched by comparing with the player who plays the game in response to a conduct order of the bowling game conducted based on the image screen or motion information recognized by the sensor recognition unit, a score management unit detecting the expected score calculated by the expected score calculation unit of the bowling game creation unit, and the current scores of the current player and the current team member, and detecting a difference between both scores, and an information providing unit transferring each of the bowling game related information including the image of the conducted bowling game, the scores of each player and team member, etc., and the expected score, the current score, and the difference score between both scorers detected by the score management unit to the portable device.

In order to achieve the object, a feature of a method for a bowling game through a network interconnect according to the present invention may include: (A) collecting bowling game participation information and bowling alley information input from a portable device and a bowling alley server interconnected and accessing a network by using an information collection unit; (B) conducting a bowling game by creating a team member by applying a penalty for each bowling average of each player based on the collected bowling game participation information by using a bowling game creation unit, and calculating an expected score of each team based on the bowling average of the created team member and transferring the calculated expected score to the portable device of the team member; (C) interlocking respective corresponding bowling alley servers with each other in order to conduct the created bowling game, authenticating a player performing the bowling game based on a screen image or motion information photographed by a camera provided in each bowling alley by using a sharing support unit; (D) calculating scores of each player and each team member, and determining rankings by using a bowling game image of each player transferred from each bowling alley based on the created team member by using a score management unit; and (E) transferring bowling game related information including an image of the conducted bowling game, and the scores of each player and each team member to the portable device by using a sharing support unit.

### Advantageous Effects

The system and the method for a bowling game through network interconnect according to the present invention described above has the following effects.

First, each player at a remote distance can participate in the bowling game in real time through the network interconnect to conveniently enjoy the bowling game with an opponent player in the other region at the remote distance without a spatial restriction.

Second, numerical information is extracted from an image of the bowling game which is in progress in offline and a record for each player is calculated and provided through a player's individual portable device to increase a fun and satisfaction in the bowling game made contact-free.

Third, a bowling alley operation in a downtown area is not required by removing local and positional restrictions through the network interconnect to allow a bowling alley manager to reduce economic cost.

Fourth, a player and a team member having a similar level to the player are matched, and a bowling exercise and the bowling game can be performed to provide fun and skill enhancement of the exercise and the bowling game to players.

Fifth, it is possible to prevent dishonesty of the bowling game conducted contact free through authentication of a player who plays the bowling game through a motion sensor (camera), etc.

Sixth, it is possible to increase accuracy of a player and bowling alley information by utilizing a cloud service with a big data analysis module, and it is possible to verify a more accurate score of a bowling average of each player to further increase fairness for creation of a team member.

In addition to the above-described effects, the specific effects of the present invention will be described below together while describing the specific matters for the present invention.

### DESCRIPTION OF DRAWINGS

FIG. 1 is a block diagram illustrating a configuration of a system for a bowling game through a network interconnect according to an embodiment of the present invention.

FIG. 2 is a block diagram specifically illustrating a configuration of a bowling game server in FIG. 1.

FIG. 3 is a block diagram specifically illustrating a configuration of an information collection unit in FIG. 2.

FIG. 4 is a block diagram specifically illustrating a configuration of a bowling game creation unit in FIG. 2.

FIG. 5 is a block diagram specifically illustrating a configuration of a score management unit in FIG. 2.

FIG. 6 is a block diagram specifically illustrating a configuration of a sharing support unit in FIG. 2.

FIG. 7 is a block diagram specifically illustrating a configuration of a storage unit in FIG. 2.

FIG. 8 is a flowchart for describing a method for a bowling game through a network interconnect according to an embodiment of the present invention.

### MODES FOR THE INVENTION

Other objects, characteristics, and advantages of the present invention will become apparent through the detailed description of the embodiments referred to in the accompanying drawings.

Terms used in the present invention adopt general terms which are currently widely used as possible by considering functions in the present invention, but the terms may be changed depending on an intention of those skilled in the art, a precedent, emergence of new technology, etc. Further, in a specific case, a term which an applicant arbitrarily selects is present and in this case, a meaning of the term will be disclosed in detail in a corresponding description part of the disclosure. Accordingly, a term used in the present disclosure should be defined based on not just a name of the term but a meaning of the term and contents throughout the present disclosure.

Preferred embodiments of a system and a method for a bowling game through a network interconnect according to an embodiment of the present invention will be described below with reference to the accompanying drawings. The present invention is not limited to an embodiment disclosed below but may be implemented in various different shapes and the present embodiment just completes a disclosure of the present invention and is provided to completely inform a scope of the present invention to those skilled in the art. Accordingly, configurations illustrated in the embodiments and drawings disclosed in the present specification are only the most preferred embodiment of the present invention and do not represent all of the technical spirit of the present invention, and thus it is to be understood that various equivalents and modified examples, which may replace the configurations, are possible when filing the present application.

Further, when it is disclosed that any component is “connected”, “coupled”, or “linked” to other components, it should be understood that the components may be directly connected or linked to each other, but another component may be “interposed” between the respective components or the respective components may be “connected”, “coupled”, or “linked” through another component.

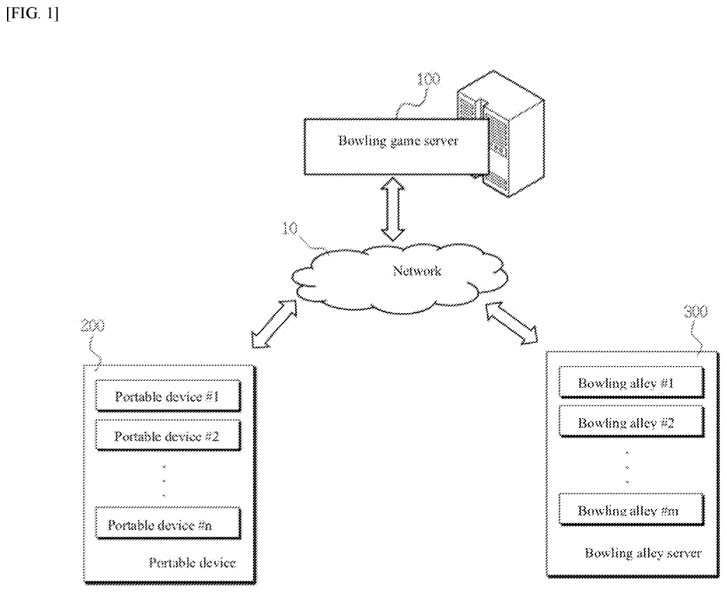

FIG. 1 is a block diagram illustrating a configuration of a system for a bowling game through a network interconnect according to an embodiment of the present invention.

As illustrated in FIG. 1, the bowling game system according to the present invention may include a bowling game server 100, a portable device 200, and a bowling alley server 300 interlocked with each other and provided to transmit and receive information to and from each other through a network 10.

The bowling game server 100 may share bowling game information through a player's individual portable device 200 so as for each player to participate in a bowling game conducted in a remote distance in real time through the network interconnect.

The bowling game server 100 may manage a game current state and a game record of the player by calculating a score for each player and each rail based on a screen image transferred from the bowling alley server 300. Further, the bowling game server 100 may perform information management of a member by constructing a database capable of providing a result calculated for each player according to a bowling game result to the player's individual portable device.

The bowling game server 100 may prevent dishonesty of the bowling game conducted contact free through authentication of a player who plays the bowling game through a motion sensor (camera), etc.

The portable device 200 as a terminal possessed by the player may include all types of handheld based wireless communication devices which may be connected to an external server such as a file management server through the network, such as a cellular phone, a smartphone, a personal digital assistant (PDA), a portable multimedia player (PMP), a tablet PC, etc., and besides, may also include a communication device which may be connected to the external server such as the file management server through the network, such as an IPTV including a desktop PC, a tablet PC, a laptop PC, and a set-top box.

An application for receiving bowling game information and bowling game service information from the bowling game server 100 through the network 10 may be installed in the portable device 200. The application may be provided from the bowling game server 100 or also provided from other smartphone application markets (e.g., Apple appstore, Google Android market, etc.) and installed.

The portable device 200 is driven by manipulation by the player, and accesses the bowling game server 100 by executing the application installed by a simple method for selecting (touch type or button type) the application displayed in a display window.

The portable device 200 may be connected to the bowling game server 100 through the network 10 including a repeater, and receive various information related to the bowling game information and the bowling game service from the bowling game server 100. The portable device 200 is connected to the network 10 to perform server-client communication with the bowling game server 100.

Further, the portable device 200 may be configured to interlock with the bowling game server 100 and receive the bowling game information and the bowling game service, and then directly pay a usage fee for service usage.

The bowling alley server 300 may manage reservation of the bowling alley and real-time information of the bowling alley, photograph the bowling game conducted in the bowling alley, and transfer a photographed screen image or motion information to the bowling game server 100 together with the information of the portable device 200.

In a bowling alley, lanes having a width of approximately 1 m and a length of approximately 23 m should be installed according to an international standard, a transport system for recovery of a ball is provided below the lane, and an apparatus for recovering and arranging pins may be equipped. In this case, the bowling alley has unique numbers for each bowling alley and each bowling rail.

The bowling alley server 300 may include a motion sensor or a first camera (hereinafter, referred to as “first camera”) that photographs the player who conducts the bowling game on a bowling rail, and a sensing sensor or a second camera (hereinafter, referred to as “second camera”) that photographs 10 bowling pins erected on the bowling lane. In addition, the bowling alley server 300 may transfer the photographed screen image or motion information photographed by the first camera and the second camera to the bowling game server 100 together with the information of the portable device 200.

Meanwhile, the bowling game server 100 and the bowling alley server 300 may have the same configuration as a general web server in terms of hardware, and include a program module that are implemented through various types of languages including C, C++, Java, Visual Basic, Visual C, etc., and performs various functions in terms of software.

The bowling game server 100 and the bowling alley server 300 may be implemented by using a web server program variously provided according to an operating system such as Dos, windows, Linux, Unix, Macintosh, etc., to a general server hardware, and representatively adopt a website used in a Windows environment, Internet Information Server (IIS), and CERN, NCSA, APPACH, etc., used in a Unix environment.

Further, the network 10 in which the bowling game server 100, the portable device 200, and the bowling alley server 300 interlock with each other may include the repeater, and provide an access route through which packet data may be transmitted and received.

The network 10 may include wired networks including Local Area Networks (LANs), Wide Area Networks (WANs), Metropolitan Area Networks (MANs), Integrated Service Digital Networks (ISDNs), etc, or wireless networks including a mobile communication network (including 3G network, 4G network, and WiBro network), Internet network/Public switched telephone network (PSTN), wireless LANs, CDMA, Bluetooth, satellite communication, etc., but the scope of the present invention is not limited thereto. The repeater may be a base station or include a wireless access device (access point (AP)).

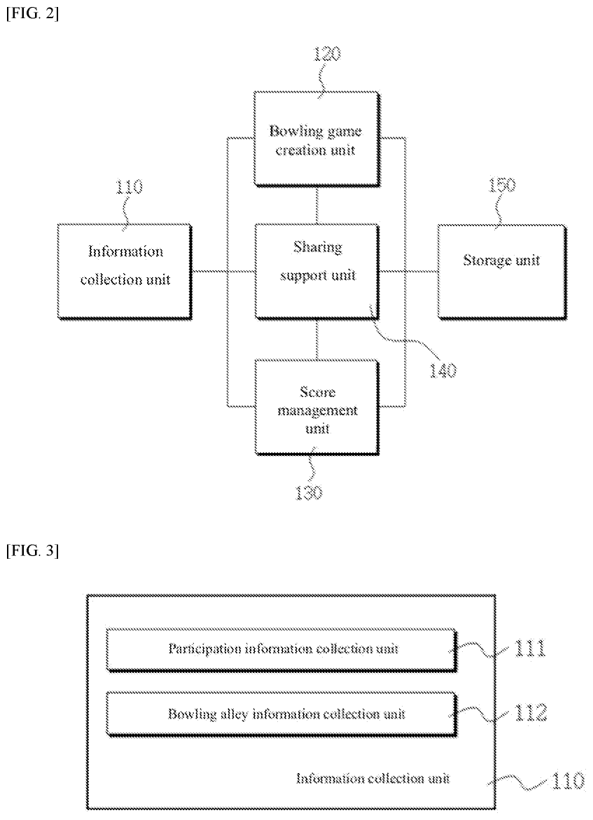

FIG. 2 is a block diagram specifically illustrating a configuration of a bowling game server in FIG. 1. The bowling game server 100 illustrated in FIG. 2 follows an embodiment, and constituent elements thereof are illustrated to the embodiment illustrated in FIG. 2 and if necessary, some constituent elements may be added, modified, or deleted.

As illustrated in FIG. 2, the bowling game server 100 may include an information collection unit 110, a bowling game creation unit 120, a score management unit 130, a sharing support unit 140, and a storage unit 150.

The information collection unit 110 is interconnected to the network 10 to collect bowling game participation information and bowling alley information input from the portable device 200 and the bowling alley server 300 interconnected and accessing the network 10. In this case, the bowling game participation information may include unique player information registered through member subscription and bowling game room information which is previously created or newly created. In addition, the bowling alley information may include bowling alley information for the bowling game.

As an example, the unique player information is an ID/PW registered in the bowling game server 100 in the member subscription, and the bowling game room is a participation room created for a so-called room chief to conduct the bowling game by distinguishing a bowling average, an age, a gender, a guild, an acquaintance, an individual game, a team game, etc., and players who intend to play the bowling game may select and participate in one of a plurality of bowling game rooms made as such.

Meanwhile, the information collection unit 110 uses big data analysis using a cloud system for collecting the bowling game participation information and the bowling alley information to increase accuracy and diversity of the collected player and bowling alley information.

Further, the bowling alley information may include a unique number representing a bowling alley which the head chief is positioned and a unique number representing a bowling rail of the corresponding bowling alley in order to conduct the bowling game with players who participate in the bowling game room. In this case, the unique number of the bowling alley and the unique number of the bowling rail may be granted to the bowling alley registered fro the bowling game server 100.

FIG. 3 is a block diagram specifically illustrating a configuration of an information collection unit in FIG. 2.

As illustrated in FIG. 3, the information collection unit 110 may include a participation information collection unit 111 collecting the bowling game participation information including the unique player information and the bowling game room information input from the portable device 200 and a bowling alley information collection unit 112 collecting the bowling alley information including the unique information of the bowling alley and the unique information of the bowling rail input from the portable device 200.

The bowling game creation unit 120 may conduct the game by creating a team member by applying a penalty for each bowling average of each player based on the bowling game participation information collected by the information collection unit 110. In this case, the bowling game creation unit 120 may calculate an expected score of each team based on the bowling average of the team member. The calculated expected score may give a target consciousness to the players of each team member when conducting the bowling game to further provide an interest and a fun of the bowling game.

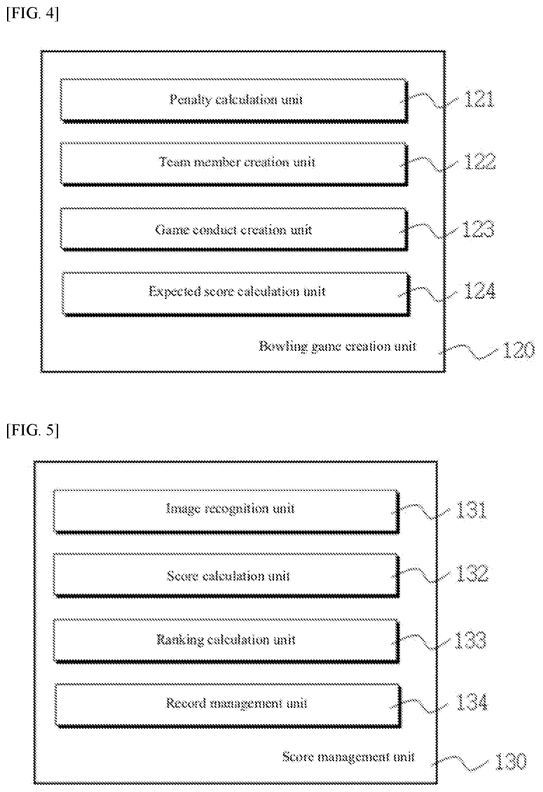

FIG. 4 is a block diagram specifically illustrating a configuration of a bowling game creation unit in FIG. 2.

As illustrated in FIG. 4, the bowling game creation unit 120 may include a penalty calculation unit 121 detecting bowling averages of all players who participate in the bowling game room in the storage unit 150 and calculating a penalty value between each player based on a difference between the detected bowling average, a team member creation unit 122 creating a team member having a smallest penalty value when each player is tied to the team member by using the penalty value calculated by the penalty calculation unit 121, a game conduct creation unit 123 conducting the bowling game by providing team member information to the portable devices 200 of all players as the team member created by the team member creation unit 122, and an expected score calculation unit 124 calculating expected information of the game by using the bowling average of each player included in the team member created by the team member creation unit 122.

In this case, the penalty value is a value representing a difference in average score between respective compared players, and as an example, when an average score of a first player is 150 and the average score of the second player is 180, the penalty value of the first player may be 0 and the penalty value of the second player may be −30.

Meanwhile, the bowling game creation unit 120 uses the big data analysis using the cloud system for detecting the bowling average of each player created as the team member to more accurately verify the bowling average score, thereby more fairly creating the team member.

Meanwhile, in the team member creation unit 122, when the selected bowling game room is set to not a group game but an individual game, the created team member may include one player.

The score management unit 130 may calculate the scores of each player and team member, and determine a ranking b using a bowling game image of each player transferred from each bowling alley based on the team member created by the bowling game creation unit 120, and store the scores and the ranking in the storage unit 150.

FIG. 5 is a block diagram specifically illustrating a configuration of a score management unit in FIG. 2.

As illustrated in FIG. 5, the score management unit 130 may include an image recognition unit 131 recognizing the bowling game image including each player and bowling pin images photographed by a camera provided in the bowling alley on the bowling rail of each bowling alley, a score calculation unit 132 calculating the bowling scores of each player and team member by using the bowling game image recognized by the image recognition unit 131, a ranking calculation unit 133 calculating the rankings of each player and team member for each bowling game based on the bowling scores calculated by the score calculation unit 132, and a record management unit 134 storing the bowling scores and the rankings in the storage unit 150 for each player and for each team member based on the bowling scores calculated by the score calculation unit 132 and the rankings calculated by the ranking calculation unit 133.

The sharing support unit 140 may interlock respective corresponding bowling alley servers 300 with each other in order to conduct the bowling game created by the bowling game creation unit 120 and authenticate the player who conducts the bowling game based on the screen image and motion information photographed by the camera provided in each bowling alley. Further, the sharing support unit 140 may transfer bowling game related information including the image of the conducted bowling game, the scores of each player and tea member, etc., to the portable device 200. Meanwhile, the sharing support unit 140 may transfer each of the expected score calculated by the expected score calculation unit 124 of the bowling game creation unit 120 and current scores of a current player and a current team member to the portable device 200.

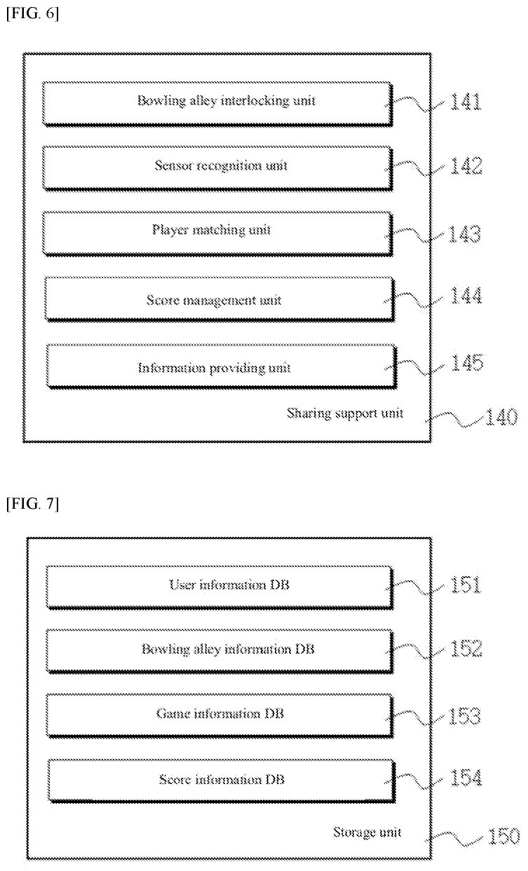

FIG. 6 is a block diagram specifically illustrating a configuration of a sharing support unit in FIG. 2.

As illustrated in FIG. 6, the sharing support unit 140 may include a bowling alley interlocking unit 141 interlocking the respective corresponding bowling alley servers 300 with each other based on the unique information of the bowling alley and the unique information of the bowling rail input fro the portable device 200 in order to conduct the bowling game created by the bowling game creation unit 120, a sensor recognition unit 142 recognizing the screen image and motion information photographed by the camera provided in each bowling alley, a player matching unit 143 authenticating whether a corresponding player is a proper player through whether the players are matched by comparing with the player who plays the game in response to a conduct order of the bowling game conducted based on the image screen or motion information recognized by the sensor recognition unit 142, a score management unit 144 detecting the expected score calculated by the expected score calculation unit 124 of the bowling game creation unit 120, and the current scores of the current player and the current team member, and detecting a difference between both scores, and an information providing unit 145 transferring each of the bowling game related information including the image of the conducted bowling game, the scores of each player and team member, etc., and the expected score, the current score, and the difference score between both scorers detected by the score management unit 144 to the portable device 200.

The storage unit 150 may store user information, bowling alley information, game, information, score information, etc.

FIG. 7 is a block diagram specifically illustrating a configuration of a storage unit in FIG. 2.

As illustrated in FIG. 7, the storage unit 150 may include a user information DB 151 storing personal information (contact, a name (nickname), portable device information, a gender, an age, etc.) input into the bowling game server 100 in the member subscription and the registered unique player information (ID/PW), a bowling alley information DB 152 storing bowling alley information (a name, a location, and a contact of the bowling alley, a unique bowling alley number, a unique number of each bowling rail, etc.) input into the bowling game server 100 in franchise subscription, a game information DB 153 storing various information related to the bowling game and bowling game service including created bowling game room information, information on the player who participate in the bowling game room, current game state and record information of the player, result information calculated for each player according to a bowling game result, etc., and a score information DB 154 storing a real-time score, an average score for each player and for each bowling rail, and the anticipated score, the current score, and the difference score detected by the score management unit 144.

An operation of the system for the bowling game through the network interconnect according to the present invention configured as above will be described below in detail with reference to the accompanying drawings. The same reference numerals as those in FIGS. 1 to 7 refer to the same members performing the same function.

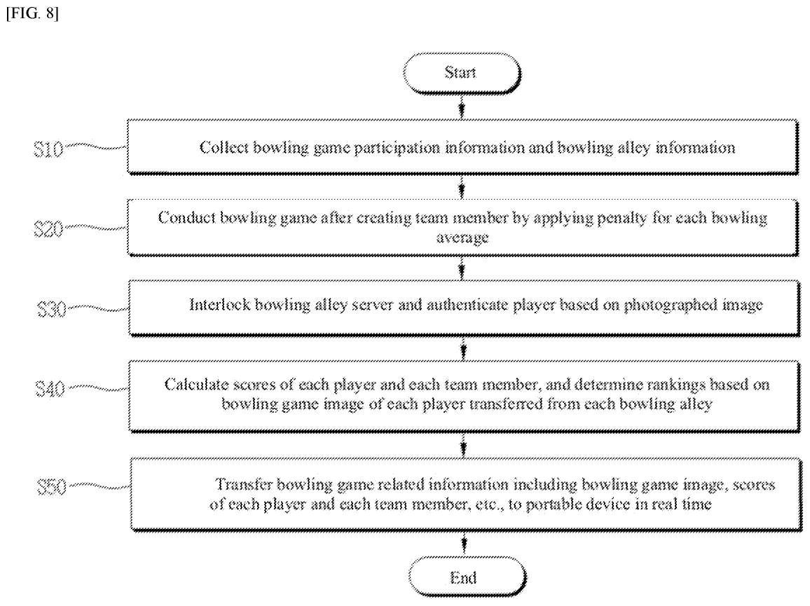

FIG. 8 is a flowchart for describing a method for a bowling game through a network interconnect according to an embodiment of the present invention.

Referring to FIG. 8, first, the bowling game server 100 is interconnected to the network 10 to collect bowling game participation information and bowling alley information input from the portable device 200 and the bowling alley server 300 interconnected and accessing the network 10 by using the information collection unit 110 (S10). In this case, the bowling game participation information may include unique player information registered through member subscription and bowling game room information which is previously created or newly created. In addition, the bowling alley information may include unique numbers of a bowling alley and a bowling rail for a bowling game.

Subsequently, the bowling game server 100 may conduct the game by creating a team member by applying a penalty for each bowling average of each player based on the bowling game participation information collected by the information collection unit 110 by using the bowling game creation unit 120 (S20). In this case, the conducted bowling game may be used on one rail by multiple persons according the number of persons who participate in the bowling alley.

Meanwhile, the bowling game creation unit 120 may calculate an expected score of each team based on a bowling average of a team member created by using the expected score calculation unit 124, and transfer the calculated expected score to the portable device 200 of the team member. In addition, the penalty value may be a value representing a difference in average score between respective players compared.

In more detail, the bowling game creation unit 120 detects the bowling averages of all players who participate in the bowling game room in the storage unit 150 by using the penalty calculation unit 121, and calculates the penalty value between the respective players based on a difference between the detected bowling averages. In addition, team members having a smallest penalty value are tied and created by using the calculated penalty value by using the team member creation unit 122. Subsequently, team member information is provided to the portable devices 200 of all players as the created team member by using the game conduct creation unit 123 to conduct the bowling game.

Next, the bowling game server 100 may interlock respective corresponding bowling alley servers 300 with each other in order to conduct the bowling game created by the bowling game creation unit 120 by using the sharing support unit 140 and authenticate the player who conducts the bowling game based on the screen image and motion information photographed by the camera provided in each bowling alley (S30). In this case, the authentication for the player is an authentication for preventing a dishonest player who performs a substitution play, and the screen image or motion information which is used for dishonesty prevention may be a still image or a moving picture.

In more detail, the sharing support unit 140 interlocks the respective corresponding bowling alley servers 300 based on the unique information of the bowling alley and the unique information of the bowling rail input from the portable device 200 in order to conduct the created bowling game by using the bowling alley interlocking unit 141. In addition, the screen image or motion information photographed by the camera provided in each bowling alley is recognized by using the sensor recognition unit 142, and then whether the players are matched by comparing the players who play the game in response to a conduct order of the bowling game conducted based on the recognized screen image or motion information by using the player matching unit 143 to authenticate whether the corresponding player is a proper player. Therefore, it is possible to prevent the dishonesty of the bowling game conducted contact-free.

Subsequently, the bowling game server 100 may calculate the scores of each player and team member, and determine rankings based on the bowling game image of each player transferred from each bowling alley based on the created team member by using the score management unit 130 (S40).

In more detail, the score management unit 130 recognizes the bowling game image of the each player and the bowling pin photographed through the camera provided in the bowling alley on the bowling rail of each bowling alley by using the image recognition unit 131. In addition, the bowling scores of each player and each team member are calculated by using the recognized bowling game image by using the score calculation unit 132, and then the rankings of each player and each team member for the bowling game are calculated based on the calculated bowling scores. In addition, the calculated rankings are stored in the storage unit 150 for each player and for each team member.

Further, the bowling game server 100 may transfer bowling game related information including the image of the conducted bowling game, the scores of each player and tea member, etc., to the portable device 200 in real time by using the sharing support unit 140 (S50). In this case, the bowling game related information may include the calculated expected score, and the current scores of the current player and the current team member.

In more detail, the sharing support unit 140 detects the expected score calculated by the expected score calculation unit 124 and the current scores of the current player and the current team member, and detects a difference between both scores by using the score management unit 144. In addition, each of the bowling game related information including the image of the conducted bowling game, the scores of each player and each team member, etc., and the expected score, the current score, and the difference score detected by the score management unit 144 is provided to the portable device 200.

Through such a network interconnect method, numerical information is extracted from an image of the bowling game which is in progress in offline and a record for each player is calculated and provided through a player's individual portable device, and as a result, each player positioned at the remote distance may participate in the bowling game in real time. Further, local and positional restrictions for the bowling game may be removed and operating the bowling alley in the downtown area is not required to reduce the economic cost for a bowling alley manager.

Meanwhile, the devices according to the disclosed embodiments may include a processor, a memory storing and executing program data, a permanent storage such as a disk drive, a communication port communicating with an external device, a user interface device such as a touch panel, a key, and a button, and the like. Methods implemented by a software module or an algorithm may be stored on a computer readable recording medium as computer-readable codes or program instructions that can be executed on the processor. Here, the computer readable recording medium includes magnetic storage media (e.g., read-only memory (ROM), random-access memory (RAM), floppy disk, hard disk, etc.), optical reading media (e.g., CD-ROM, and digital versatile disc (DVD)), and the like. The computer readable recording media may be stored and executed with codes which may be distributed in computer systems connected via a network and read by a computer in a distribution method. The media are readable by a computer, stored in memory, and may be executed in the processor.

All documents including publications, patent applications, patents, etc. cited in the disclosed embodiments are illustrated by combining each cited reference individually and specifically, or combined with embodiments disclosed in the same manner as those combined and indicated in the published embodiment as a whole.

In order to understand the disclosed embodiments, reference numerals are given in the preferred embodiments shown in the drawings, specific terms have been used to describe the disclosed embodiments, but the disclosed embodiments are not limited by the specific terms, and the disclosed embodiments may include all components commonly conceived by those skilled in the art.

The disclosed embodiments may be represented by functional block configurations and various processing steps. These functional blocks may be implemented as various numbers of hardware or/and software configurations for executing specific functions. For example, the disclosed embodiments may adopt IC configurations such as a memory, a processing, a logic, a look-up table, and the like, which may execute various functions by control of one or more microprocessors or other control devices. The components of the disclosed embodiments include various algorithms implemented in combination of a data structure, processes, routines, or other programming configurations like being executed by software programming or software elements to be implemented by a programming or scripting language such as C, C++, Java, assembler, and the like. Functional aspects may be implemented as an algorithm executed in one or more processors. In addition, the disclosed embodiments may adopt the related art for electronic environment configuration, signal processing, and/or data processing. The terms “mechanism”, “element”, “means”, and “configuration” can be widely used and are not limited to mechanical and physical configurations. The terms may include the meaning of a series of processes (routines) of software in conjunction with a processor or the like.

The specific implementations described in the disclosed embodiments are examples, and do not limit the scope of the disclosed embodiments in any way. For brevity of the specification, descriptions of conventional electronic configurations, control systems, software, and other functional aspects of the systems may be omitted. In addition, the connection or connection members of the lines between the components illustrated in the drawings exemplarily represent functional connections and/or physical connections, and in an actual device, may be illustrated as various functional connections, physical connections, or circuit connections that can be replaced or added. In addition, unless there is a specific reference such as “essential”, “important”, etc., it may not be an essential component for application of the disclosed embodiment. It will be understood to those skilled in the art that various embodiments may be made without departing from the technical spirit of the present invention. Therefore, the true technical scope of the present invention should be defined by the technical spirit of the appended claims.

### EXPLANATION OF REFERENCE NUMERALS AND SYMBOLS

100: Bowling game server
110: Information collection unit
111: Participation information collection unit
112: Bowling alley information collection unit
120: Bowling game creation unit
121: Penalty calculation unit
122: Team member creation unit
123: Game conduct creation unit
124: Expected score calculation unit
130: Score management unit
131: Image recognition unit
132: Score calculation unit
133: Ranking calculation unit
134: Record management unit
140: Sharing support unit
141: Bowling alley interlocking unit
142: Sensor recognition unit
143: Player matching unit
144: Score management unit
145: Information providing unit
150: Storage unit
151: User information DB
152: Bowling alley information DB
153: Game information DB
154: Score information DB
200: Portable device
300: Bowling alley server

1. A system for a bowling game through a network interconnect, the system comprising:
an information collection unit collecting bowling game participation information and bowling alley information input from a portable device and a bowling alley server interconnected and accessing a network;
a bowling game creation unit creating a team member by applying a penalty for each bowling average of each player based on the collected bowling game participation information;
a score management unit calculating scores of each player and each team member, and determining rankings by using a bowling game image of each player transferred from each bowling alley based on the created team member; and
a sharing support unit interlocking respective corresponding bowling alley servers with each other in order to conduct the created bowling game, authenticating a player performing the bowling game based on a screen image or motion information photographed by a camera provided in each bowling alley, and transferring bowling game related information including an image of the conducted bowling game, and the scores of each player and each team member to the portable device.

2. The system for a bowling game through a network interconnect of claim 1, wherein
the score management unit includes
an image recognition unit recognizing a bowling game image including each player and bowling pin images photographed through the camera provided in the bowling alley on a bowling rail of each bowling alley,
a score calculation unit calculating bowling scores of each player and each team member by using the recognized bowling game image,
a ranking calculation unit calculating the rankings of each player and each team member for the bowling game based on the calculated bowling score, and
a record management unit storing the bowling score and the ranking in a storage unit for each player and for each team member.

3. A method for a bowling game through a network interconnect, the method comprising:
(A) collecting bowling game participation information and bowling alley information input from a portable device and a bowling alley server interconnected and accessing a network by using an information collection unit;
(B) conducting a bowling game by creating a team member by applying a penalty for each bowling average of each player based on the collected bowling game participation information by using a bowling game creation unit, and calculating an expected score of each team based on the bowling average of the created team member and transferring the calculated expected score to the portable device of the team member;
(C) interlocking respective corresponding bowling alley servers with each other in order to conduct the created bowling game, authenticating a player performing the bowling game based on a screen image or motion information photographed by a camera provided in each bowling alley by using a sharing support unit;
(D) calculating scores of each player and each team member, and determining rankings by using a bowling game image of each player transferred from each bowling alley based on the created team member by using a score management unit; and
(E) transferring bowling game related information including an image of the conducted bowling game, and the scores of each player and each team member to the portable device by using a sharing support unit.
